(19) United States
(12) Patent Application Publication
(10) Pub. No.: US 2022/0301377 A1
(43) Pub. Date: Sep. 22, 2022

(54) DEPOSIT AND WITHDRAWAL APPARATUS AND COIN DISTRIBUTION METHOD

(71) Applicant: FUJITSU FRONTECH LIMITED, Tokyo (JP)

(72) Inventors: Mitsuo WATANABE, Inagi (JP); Masanori OHKAWA, Inagi (JP); Gen SATO, Inagi (JP); Toshimasa MIYAKE, Inagi (JP); Nobuhiro MATSUI, Inagi (JP); Yasushi KAWAMURA, Inagi (JP)

(73) Assignee: FUJITSU FRONTECH LIMITED, Tokyo (JP)

(21) Appl. No.: 17/837,739

(22) Filed: Jun. 10, 2022

Related U.S. Application Data
(63) Continuation of application No. PCT/JP2019/049968, filed on Dec. 19, 2019.

(51) Int. Cl. G07D 1/06; G07D 3/16; G07D 3/14

(52) U.S. Cl. CPC G07D 1/06; G07D 3/16; G07D 3/14

(57) ABSTRACT

A deposit and withdrawal apparatus that includes a deposit port through which a coin is deposited, a withdrawal port through which the coin is withdrawn, and a first unit that is capable of storing the coin includes a second unit, a judgement unit, and a distribution unit. The second unit is different from the first unit and is capable of storing the coin. The judgement unit judges the coin deposited from the deposit port. The distribution unit distributes the deposited coin to the first unit or the second unit on the basis of a judgement result obtained by the judgement unit. The distribution unit is able to distribute the coin deposited into the first unit or the second unit.

### CROSS-REFERENCE TO RELATED APPLICATION

This application is a continuation application of International Application PCT/JP2019/049968, filed on Dec. 19, 2019, and designating the U.S., the entire contents of which are incorporated herein by reference.

### FIELD

The present invention relates to a deposit and withdrawal apparatus and a coin distribution method.

### BACKGROUND

There is a deposit and withdrawal apparatus used for depositing a sum of money corresponding to a commodity product when, for example, a customer purchases the commodity product at a store, such as a supermarket. The deposit and withdrawal apparatus includes a coin recycling unit that stores therein coins for each denomination, and the number of coins that can be withdrawn by the deposit and withdrawal apparatus greatly depends on the coin storage capacity of the coin recycling unit.
Patent Literature 1: Japanese Laid-open Patent Publication No. 2019-101891
Patent Literature 2: Japanese Laid-open Patent Publication No. 2019-185571
Patent Literature 3: Japanese Laid-open Patent Publication No. 2015-102926

Accordingly, in the deposit and withdrawal apparatus, for example, it is conceivable to adopt a large-capacity coin recycling unit in which the number of stored coins is increased; however, the size of the deposit and withdrawal apparatus itself is increased in accordance with the size of the large-capacity coin recycling unit. Thus, in the deposit and withdrawal apparatus, it is conceivable to adopt a small-capacity coin recycling unit in order to reduce the size of the deposit and withdrawal apparatus itself; however, a frequency in which the number of stored coins in the coin recycling unit enters a full state is increased. Consequently, coins are discharged from the coin recycling unit in order to resolve the full state in the coin recycling unit; however, an accounting process is temporarily stopped in a period of time for which the coins are discharged, and thus, an operation rate of the accounting process is decreased.

Furthermore, in the deposit and withdrawal apparatus, for example, even when a commemorative coin or the like is deposited, a reject operation is generally performed without accepting a deposit of the commemorative coin.

Thus, the actual circumstances is that there is a need to provide a deposit and withdrawal apparatus that includes another unit that is different from the coin recycling unit and that has a function for distributing coins to the other unit before the coin recycling unit enters the full state or a function for distributing the commemorative coin to the other unit even when, for example, the commemorative coin or the like is inserted.

### SUMMARY

A deposit and withdrawal apparatus includes a deposit port through which a coin is deposited, a withdrawal port through which the coin is withdrawn, and a first unit that is capable of storing the coin. The deposit and withdrawal apparatus comprises a second unit that is different from the first unit and that is capable of storing the coin; a judgement unit that judges the coin deposited from the deposit port; and a distribution unit that distributes, based on a judgement result of the judgement unit, the deposited coin to the first unit or the second unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a deposit and withdrawal apparatus according to an embodiment.

FIG. 2 is a schematic diagram of a front view illustrating an example of the deposit and withdrawal apparatus.

FIG. 3 is a schematic diagram of a side view illustrating an example of the deposit and withdrawal apparatus.

FIG. 4 is a block diagram illustrating an example of a functional configuration of the deposit and withdrawal apparatus according to a first embodiment.

FIG. 5 is a diagram illustrating an example of an operation of a coin recycling unit.

FIG. 6 is a diagram illustrating an example of a stored coin count table for managing the number of coins in a coin temporary suspending section and each denomination hopper.

FIG. 7 is a diagram illustrating an example of a threshold table for managing a threshold in the coin temporary suspending sections and each of the denomination hoppers.

FIG. 8 is a block diagram illustrating an example of a functional configuration of a controller unit.

FIG. 9 is a flowchart illustrating an example of a processing operation of the deposit and withdrawal apparatus related to a first deposit and withdrawal process.

FIG. 10 is a flowchart illustrating an example of a processing operation of the deposit and withdrawal apparatus related to the first deposit and withdrawal process.

FIG. 11 is a flowchart illustrating an example of a processing operation of a coin unit related to a first coin sorting process.

FIG. 12 is a flowchart illustrating an example of a processing operation of the coin unit related to a coin withdrawal process.

FIG. 13 is a flowchart illustrating an example of a processing operation of the coin unit related to a coin replenishment process.

FIG. 14 is a flowchart illustrating an example of a processing operation of the coin unit related to a coin collection process.

FIG. 15 is a block diagram illustrating an example of a functional configuration of a deposit and withdrawal apparatus according to a second embodiment.

FIG. 16 is a flowchart illustrating an example of a processing operation of the deposit and withdrawal apparatus related to a second deposit and withdrawal process.

FIG. 17 is a flowchart illustrating an example of a processing operation of the coin unit related to a coin setting process.

FIG. 18 is a flowchart illustrating an example of a processing operation of a coin unit related to a second coin sorting process.

### DESCRIPTION OF EMBODIMENTS

Preferred embodiments of a deposit and withdrawal apparatus or the like disclosed in the present invention will be explained in detail below with reference to the accompanying drawings. Moreover, the disclosed technology is not limited to the embodiments described below. Furthermore, the embodiments described below may also be used in any appropriate combination as long as the embodiments do not conflict with each other.

### First Embodiment

### Configuration of Deposit and Withdrawal Apparatus 1

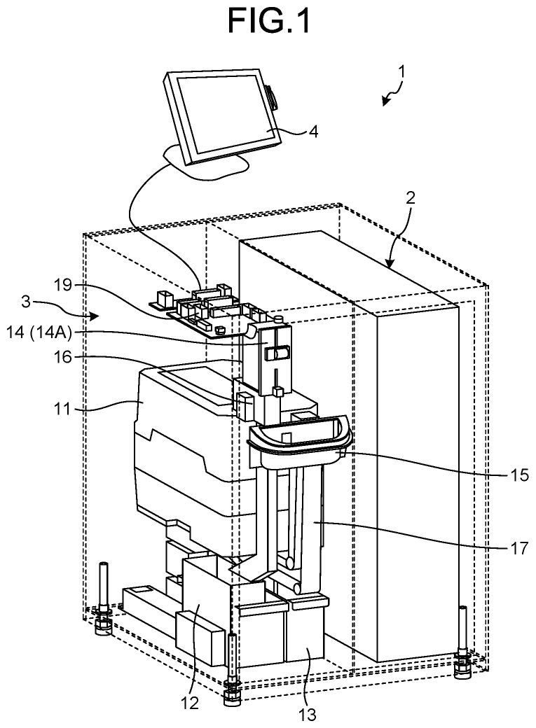

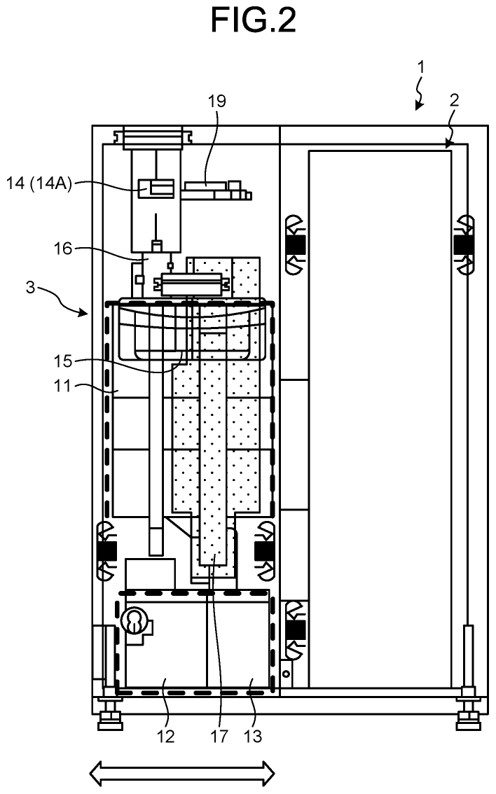

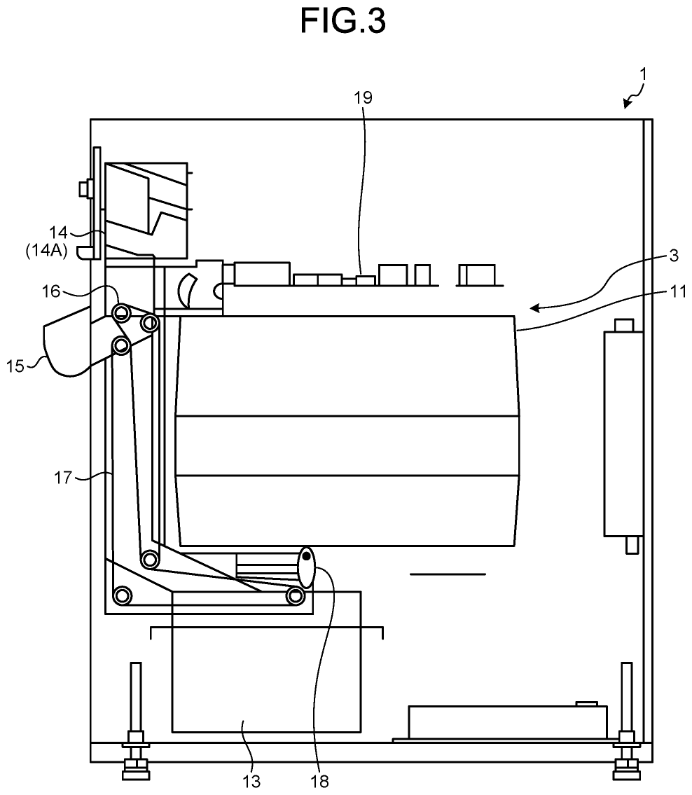

FIG. 1 is a diagram illustrating an example of a deposit and withdrawal apparatus 1 according to an embodiment, FIG. 2 is a schematic diagram of a front view illustrating an example of the deposit and withdrawal apparatus 1, and FIG. 3 is a schematic diagram of a side view illustrating an example of the deposit and withdrawal apparatus 1. The deposit and withdrawal apparatus 1 illustrated in FIG. 1 includes a banknote recycling unit 2, a coin unit 3, and a controller unit 4. The banknote recycling unit 2 is a unit through which a banknote is deposited and withdrawn. The coin unit 3 is a unit thorough which a coin is deposited and withdrawn. The controller unit 4 is a unit that instructs a command to the deposit and withdrawal apparatus 1, and that displays information, such as a state of the deposit and withdrawal apparatus 1 or a purchase amount of a product.

The coin unit 3 includes a coin recycling unit 11, a coin overflow cassette 12, a coin collection cassette 13, a coin acceptor 14, a coin withdrawal port 15, a coin sorting unit 16, a coin lifter unit 17, a coin collection stopper 18, and a control unit 19.

The coin recycling unit 11 is a unit that stores therein coins deposited from the coin acceptor (deposit port) 14 and that stores therein coins that are able to be withdrawn from the coin withdrawal port (withdrawal port) 15. The coin overflow cassette 12 is a unit that stores therein coins that are not able to be withdrawn from the coin withdrawal port 15. Moreover, the coins that are being stored in the coin overflow cassette 12 are coins that are moved in order to avoid a full state of the coin recycling unit 11; therefore, for example, these coins can be said as the coins that are available to reuse in a store. The coin collection cassette 13 is a cassette that stores therein collected coins stored in the coin unit 3, in particular, in the coin recycling unit 11. Moreover, the coins stored in the coin collection cassette 13 are coins that are put in a bank as, for example, proceeds from sale. The coin acceptor 14 corresponds to a coin deposit port 14A that is used for a deposit of coins corresponding to a billing amount of a product or the like, and has a discrimination function for discriminating the coins inserted from the coin deposit port 14A. The discrimination function is a function for discriminating whether the coin inserted into the coin deposit port 14A is an official coin, a counterfeit coin, a commemorative coin, or the like. Furthermore, the discrimination function also has a function for identifying denominations of the coins inserted into the coin deposit port 14A. The coin withdrawal port 15 corresponds to a withdrawal port through which a coin, such as change, is withdrawn. The control unit 19 performs overall control of the coin unit 3.

The coin sorting unit 16 is a distribution unit that distributes the coins inserted from the coin acceptor 14 to the coin recycling unit 11, the coin overflow cassette 12, and the coin withdrawal port 15. In addition, if the coin inserted into the coin deposit port 14A is an official coin on the basis of a discrimination result obtained from the discrimination function, the coin sorting unit 16 distributes the official coin to the coin recycling unit 11 or the coin overflow cassette 12. If the coin inserted into the coin deposit port 14A is a counterfeit coin, the coin sorting unit 16 distributes the counterfeit coin to the coin withdrawal port 15.

The coin collection stopper 18 is a stopper for opening and closing a coin discharge port 22 that discharges the coins for each of denomination hoppers 21 included in the coin recycling unit 11. The coin lifter unit 17 is a lift (conveying unit) that conveys, to the coin acceptor 14, the coins discharged from the coin discharge port 22 in accordance with an opening operation of the coin collection stopper 18 that opens and closes each of the denomination hoppers 21 included in the coin recycling unit 11 in accordance with a forward rotation operation of the coin lifter unit 17. The coin lifter unit 17 is a lift (conveying unit) that conveys, to the coin collection cassette 13, the coins discharged from the coin discharge port 22 in accordance with an opening operation of the coin collection stopper 18 that opens and closes each of the denomination hoppers 21 in accordance with a backward rotation operation of the coin lifter unit 17.

The control unit 19 includes a judgement unit 19A that performs judgement of the coins inserted from the coin acceptor 14. The judgement unit 19A judges whether a sum total of the number of coins of the number of coins inserted from the coin acceptor 14 and the number of stored coins stored in the coin recycling unit 11 is greater than or equal to an upper limit on the number of coins, which will be described later, of the coin recycling unit 11.

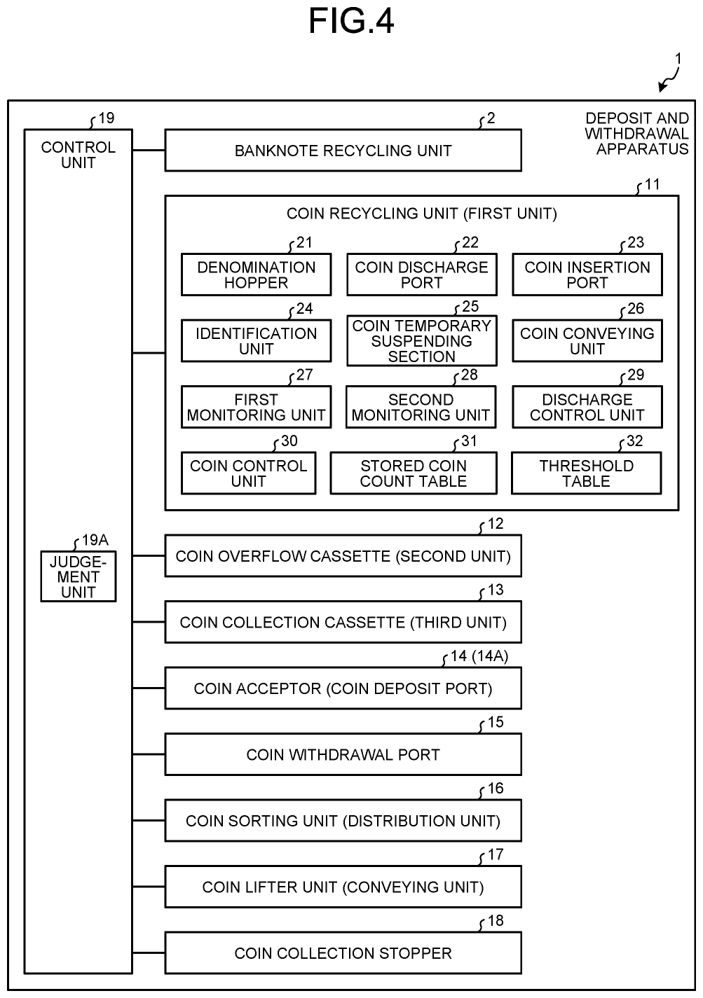

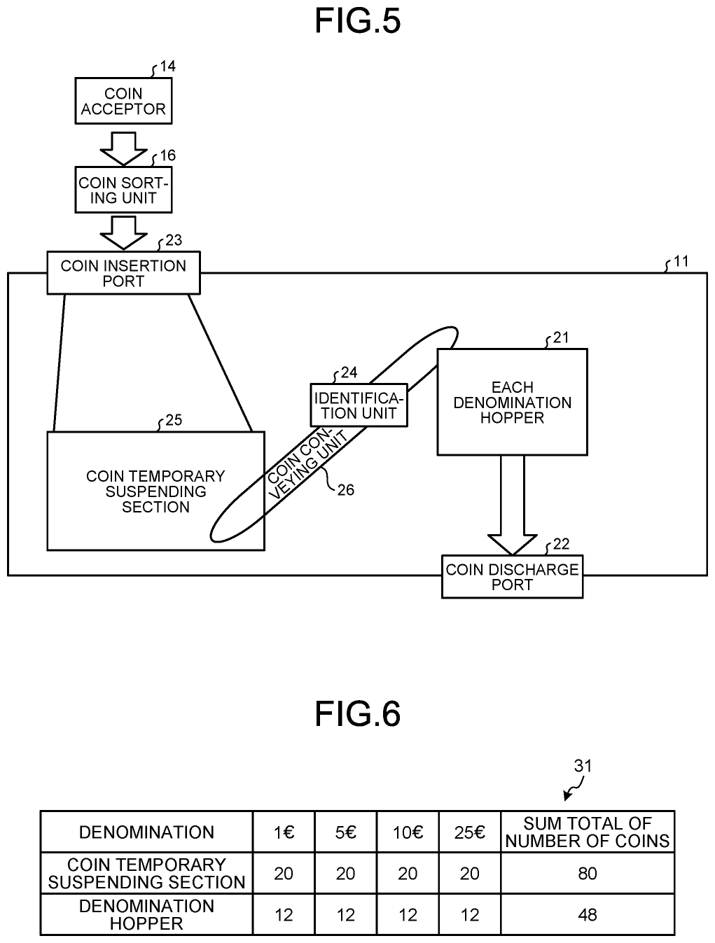

FIG. 4 is a block diagram illustrating an example of a functional configuration of the deposit and withdrawal apparatus 1 according to the first embodiment. The deposit and withdrawal apparatus 1 illustrated in FIG. 5 includes the banknote recycling unit 2, the coin recycling unit 11, the coin overflow cassette 12, the coin collection cassette 13, the coin acceptor 14, the coin withdrawal port 15, the coin sorting unit 16, the coin lifter unit 17, the coin collection stopper 18, and the control unit 19.

The coin recycling unit 11 includes, in addition to the denomination hoppers 21 and the coin discharge port 22, a coin insertion port 23, an identification unit 24, a coin temporary suspending section 25, a coin conveying unit 26, a first monitoring unit 27, a second monitoring unit 28, a discharge control unit 29, a coin control unit 30, a stored coin count table 31, and a threshold table 32.

The coin insertion port 23 is an insertion port for inserting the coins from the coin sorting unit 16 to the coin recycling unit 11. The identification unit 24 identifies the denominations or the like of the coins inserted from the coin insertion port 23. The coin discharge port 22 is a discharge port that discharges the coins from the coin recycling unit 11. The coin temporary suspending section 25 is a storage section that temporarily suspends and stores therein the coins that are inserted from the coin insertion port 23 and that have been identified by the identification unit 24. The denomination hopper 21 is a storage section that is provided for each denomination and that stores therein, for each denomination, the coins suspended in the coin temporary suspending section 25 on the basis of the identification result obtained from the identification unit 24. The coin conveying unit 26 conveys the coin for each denomination between the coin temporary suspending section 25 and the respective denomination hoppers 21. The first monitoring unit 27 monitors the number of coins, for each denomination, that are being suspended in the coin temporary suspending section 25. The second monitoring unit 28 monitors the number of coins, for each denomination, that are being stored in the respective denomination hoppers 21. The discharge control unit 29 performs control of a transfer of the coins stored in the respective denomination hoppers 21 to the coin discharge port 22. The coin control unit 30 performs overall control of the coin recycling unit 11.

FIG. 5 is a diagram illustrating an example of an operation of the coin recycling unit 11. The coin sorting unit 16 distributes the coins inserted into the coin acceptor 14 to the coin insertion port 23 included in the coin recycling unit 11. The coin temporary suspending section 25 temporarily suspends the coins inserted from the coin insertion port 23. The coin conveying unit 26 conveys the coins that are temporarily suspended by the coin temporary suspending section 25 to the respective denomination hoppers 21. The identification unit 24 identifies the coins that are being conveyed to the coin conveying unit 26 between the coin temporary suspending section 25 and each of the denomination hoppers 21. The coin conveying unit 26 conveys, on the basis of the identification result obtained by the identification unit 24, the conveying coins to the respective denomination hoppers 21 in accordance with the denominations associated with the conveying coins.

Each of the denomination hoppers 21 stores therein the coins, for each denomination, that are conveyed by the coin conveying unit 26. Furthermore, the discharge control unit 29 discharges, in accordance with an instruction related to change, the coins needed for the change from the denomination hoppers 21 to the coin discharge port 22. As a result, the coin recycling unit 11 outputs the coins in accordance with the change to the coin lifter unit 17.

FIG. 6 is a diagram illustrating an example of the stored coin count table 31 that manages the number of coins stored in the coin temporary suspending section 25 and the denomination hoppers 21. The first monitoring unit 27 counts, for each denomination, the number of coins that are being suspended in the coin temporary suspending section 25. The second monitoring unit 28 counts, for each denomination, the number of coins that are being suspended in the respective denomination hoppers 21. The coin control unit 30 stores, in the stored coin count table 31, the number of coins corresponding to the monitoring results obtained from the first monitoring unit 27 and the second monitoring unit 28.

The stored coin count table 31 illustrated in FIG. 6 manages the number of coins that are being suspended for each denomination by the coin temporary suspending section 25 and also manages the number of coins that are being stored for each denomination in the respective denomination hoppers 21. The coin control unit 30 and the discharge control unit 29 refer to the stored coin count table 31 and is able to identify the number of coins that are being stored in the coin temporary suspending section 25 and the respective denomination hoppers 21.

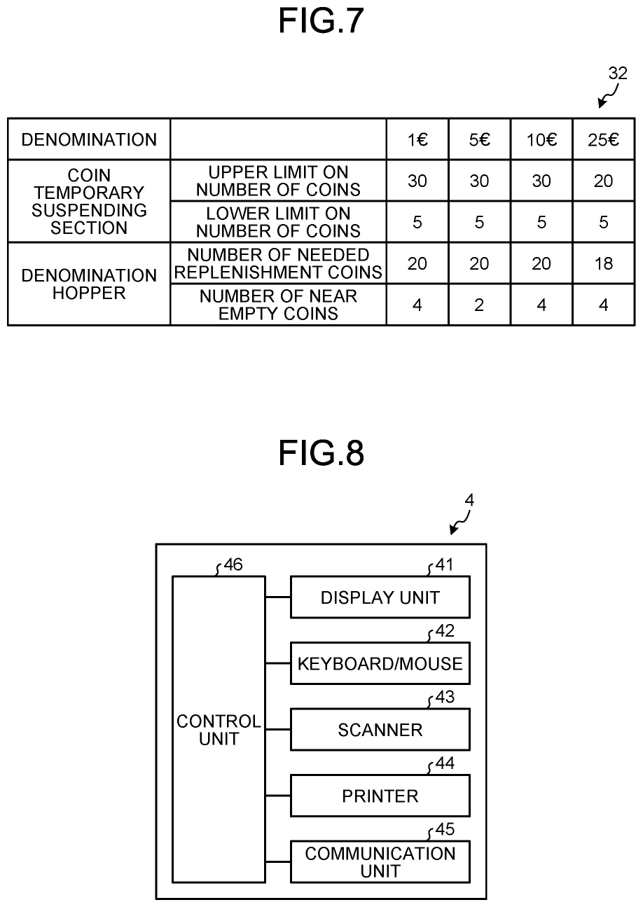

FIG. 7 is a diagram illustrating an example of the threshold table 32 that manages a threshold of each of the coin temporary suspending section 25 and the denomination hoppers 21. The threshold table 32 manages, for each denomination, an upper limit on the number of coins, a lower limit on the number of coins, the number of needed replenishment coins, and the number of near empty coins. The upper limit on the number of coins is a threshold indicating an upper limit on the number of coins that can be stored in the denomination hoppers 21 and the coin temporary suspending section 25. The lower limit on the number of coins is a threshold indicating a lower limit on the number of coins that can be stored in the denomination hoppers 21 and the coin temporary suspending section 25. The number of needed replenishment coins is a threshold indicating the number of coins requested to be replenished into the denomination hoppers 21, i.e., the minimum number of needed coins. The number of near empty coins is a threshold indicating the number of coins used when a prior warning is output before the subject denomination hopper 21 becomes empty. Moreover, for convenience of description, as an example of the upper limit on the number of coins, the number of coins in a full state that corresponds to the upper limit of each of the denomination hoppers 21 and the coin temporary suspending section 25 is used; however, the upper limit on the number of coins may be the number of coins in a near full state, and an appropriate modification is possible.

The judgement unit 19A included in the control unit 19 judges whether the number of coins (sum total of the number of coins) that are being stored in the denomination hopper 21 and the coin temporary suspending section 25 is greater than or equal to the upper limit on the number of coins. If the sum total of the number of coins is greater than or equal to the upper limit on the number of coins, the control unit 19 controls the coin sorting unit 16 such that insertion of a coin into the coin insertion port 23, i.e., insertion of the coin into the coin recycling unit 11 is inhibited in order to allow the coin to be inserted into the coin overflow cassette 12. Furthermore, if the sum total of the number of coins is not greater than or equal to the upper limit on the number of coins, the control unit 19 controls the coin sorting unit 16 in order to allow the coin to be inserted into the coin insertion port 23 included in the coin recycling unit 11. If the number of coins that are being stored in the denomination hopper 21 is less than or equal to the number of needed replenishment coins, the coin control unit 30 outputs an alarm for requesting replenishment of the coins to the associated denomination hopper 21. If the number of coins that are being stored in the denomination hopper 21 is less than or equal to the number of near empty coins, the coin control unit 30 outputs an alarm for requesting replenishment of the coins to the associated denomination hopper 21.

Configuration of Controller Unit 4

FIG. 8 is a block diagram illustrating an example of a functional configuration of the controller unit 4. The controller unit 4 illustrated in FIG. 8 includes a display unit 41, a keyboard/mouse 42, a scanner 43, a printer 44, a communication unit 45, and a control unit 46. The display unit 41 is an output interface for displaying various kinds of information on, for example, a billing amount of a product. The keyboard/mouse 42 is an input interface for inputting various kinds of information on, for example, a command. The scanner 43 is an input interface for reading out, for example, a bar code or the like attached to a product. The printer 44 is an output interface for performing print out of various kinds of information on, for example, a purchased receipt of a product. The communication unit 45 is a communication interface connected to the banknote recycling unit 2 and the coin unit 3 by using wireless communication. The control unit 46 performs overall control of the controller unit 4.

Operation of Deposit and Withdrawal Apparatus 1

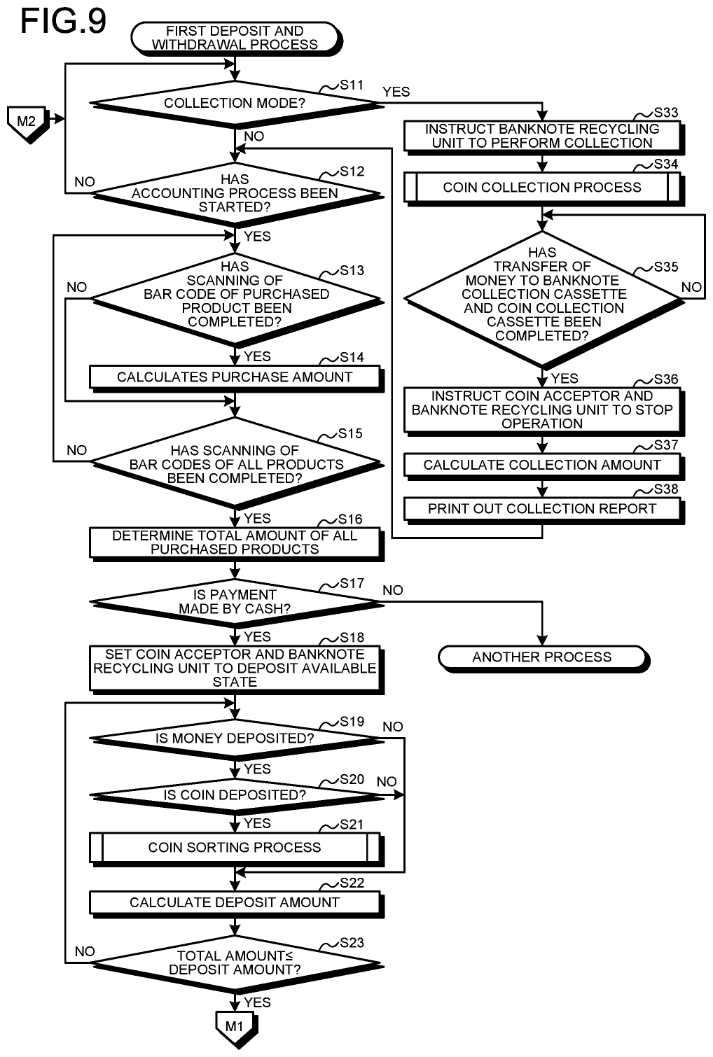

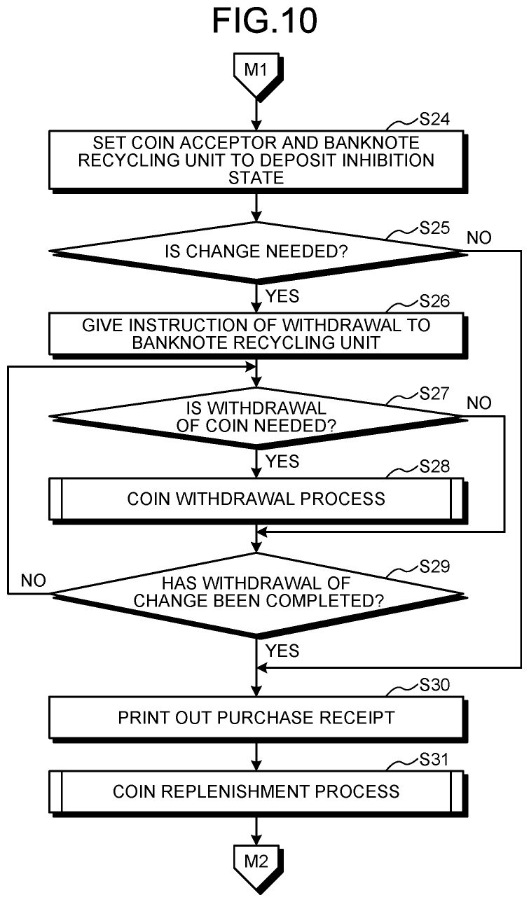

FIG. 9 and FIG. 10 are flowcharts each illustrating an example of a processing operation of the deposit and withdrawal apparatus 1 related to a first deposit and withdrawal process. In FIG. 9, the deposit and withdrawal apparatus 1 judges whether a current mode is a collection mode (Step S11). If the current mode is not the collection mode (No at Step S11), the deposit and withdrawal apparatus 1 judges whether an accounting process on the product has been started (Step S12).

If the deposit and withdrawal apparatus 1 starts the accounting process on the product (Yes at Step S12), the deposit and withdrawal apparatus 1 judges whether scanning of a bar code of a product has been completed through the scanner 43 (Step S13). If the scanning of the bar code of the product has been completed (Yes at Step S13), the deposit and withdrawal apparatus 1 calculates a purchase amount of the product on the basis of the scanning result (Step S14).

The deposit and withdrawal apparatus 1 judges whether the scanning of the bar codes of all of the products corresponding to the accounting target has been completed (Step S15). If the scanning of the bar codes of all of the products corresponding to the accounting target has been completed (Yes at Step S15), the deposit and withdrawal apparatus 1 determines the total amount of all of the products corresponding to the accounting target (Step S16).

If the total amount of all of the products corresponding to the accounting target has been determined, the deposit and withdrawal apparatus 1 judges whether a payment is made by cash (Step S17). If the payment is made by cash (Yes at Step S17), the deposit and withdrawal apparatus 1 sets the coin acceptor 14 and the banknote recycling unit 2 to a deposit available state (Step S18). As a result, the coin acceptor 14 and the banknote recycling unit 2 are able to accept a deposit.

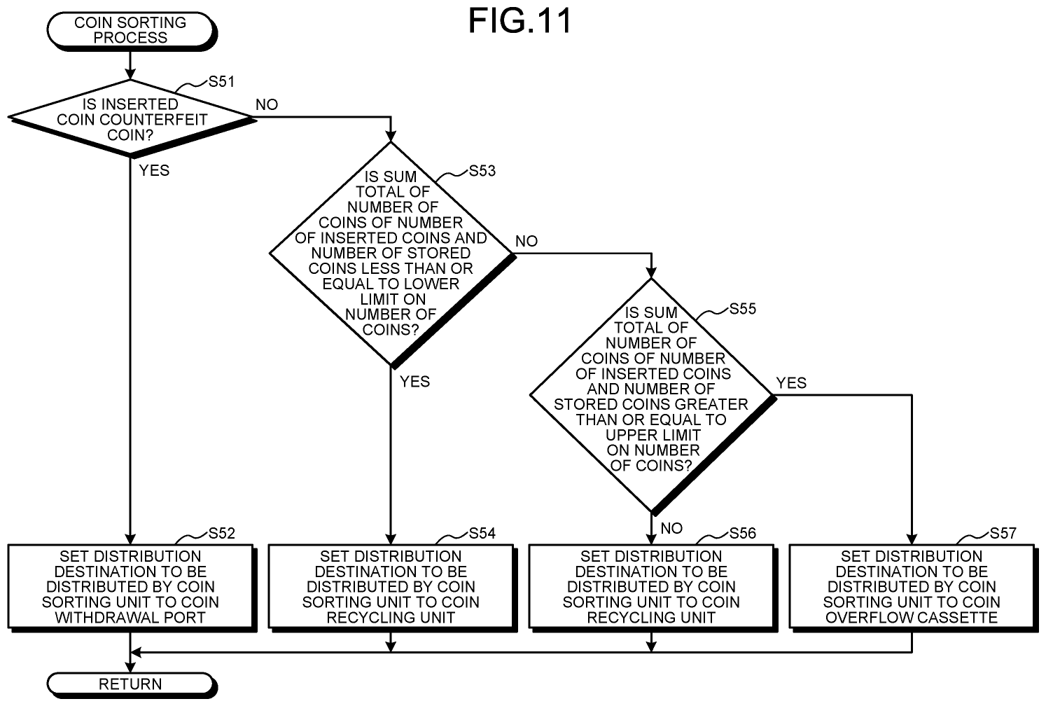

After the deposit and withdrawal apparatus 1 sets the coin acceptor 14 and the banknote recycling unit 2 to the deposit available state, the deposit and withdrawal apparatus 1 judges whether money is deposited (Step S19). If money is deposited (Yes at Step S19), the deposit and withdrawal apparatus 1 judges whether a coin out of the money is deposited (Step S20). If a coin is deposited (Yes at Step S20), the deposit and withdrawal apparatus 1 performs a coin sorting process illustrated in FIG. 11 (Step S21). After having performed the coin sorting process, the deposit and withdrawal apparatus 1 calculates a deposit amount (Step S22). The deposit and withdrawal apparatus 1 judges whether the deposit amount is greater than or equal to the total amount (Step S23). If the deposit amount is greater than or equal to the total amount (Yes at Step S23), the deposit and withdrawal apparatus 1 proceeds to M1 illustrated in FIG. 10.

In M1 illustrated in FIG. 10, if the deposit amount is greater than or equal to the total amount (Yes at Step S23), the deposit and withdrawal apparatus 1 sets the coin acceptor 14 and the banknote recycling unit 2 to a deposit inhibition state (Step S24). As a result, the coin acceptor 14 and the banknote recycling unit 2 set the state of the deposit to the inhibition state in order to allow change to be withdrawn. After the deposit and withdrawal apparatus 1 sets the coin acceptor 14 and the banknote recycling unit 2 to the deposit inhibition state, the deposit and withdrawal apparatus 1 judges whether change is needed on the basis of a difference between the total amount and the deposit amount (Step S25).

If change is needed (Yes at Step S25), the deposit and withdrawal apparatus 1 gives an instruction about a withdrawal to the banknote recycling unit 2 (Step S26). Furthermore, the deposit and withdrawal apparatus 1 judges whether a withdrawal of a coin is needed (Step S27). Moreover, the withdrawal instruction given to the banknote recycling unit 2 performed at Step S26 judges whether change of a banknote is needed and, if change of a banknote is needed, change of the banknote is withdrawn and, if change of a banknote is not needed, change of the banknote is not withdrawn, and then, the process proceeds to Step S27 in order to judge whether a withdrawal of a coin is needed.

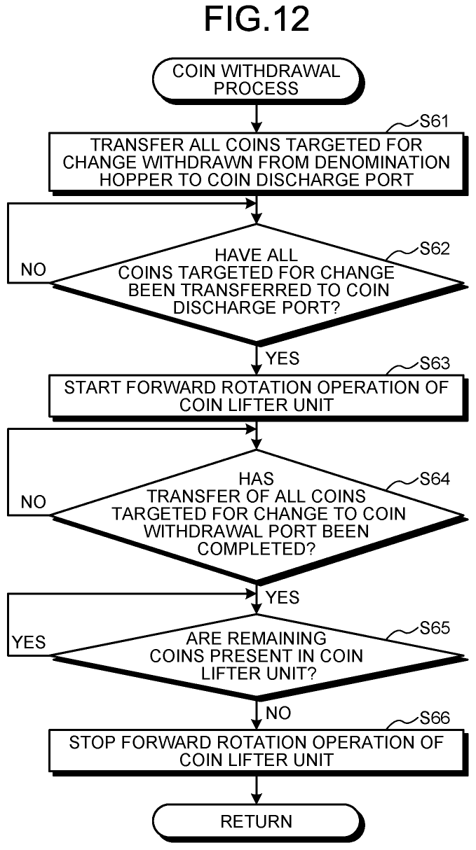

If a withdrawal of a coin is needed (Yes at Step S27), the deposit and withdrawal apparatus 1 performs a coin withdrawal process illustrated in FIG. 12 (Step S28). As a result, the coin withdrawal process is a process for withdrawing coins needed for, for example, change or the like. After having performed the withdrawal process of the coins, the deposit and withdrawal apparatus 1 judges whether withdrawal of change has been completed (Step S29).

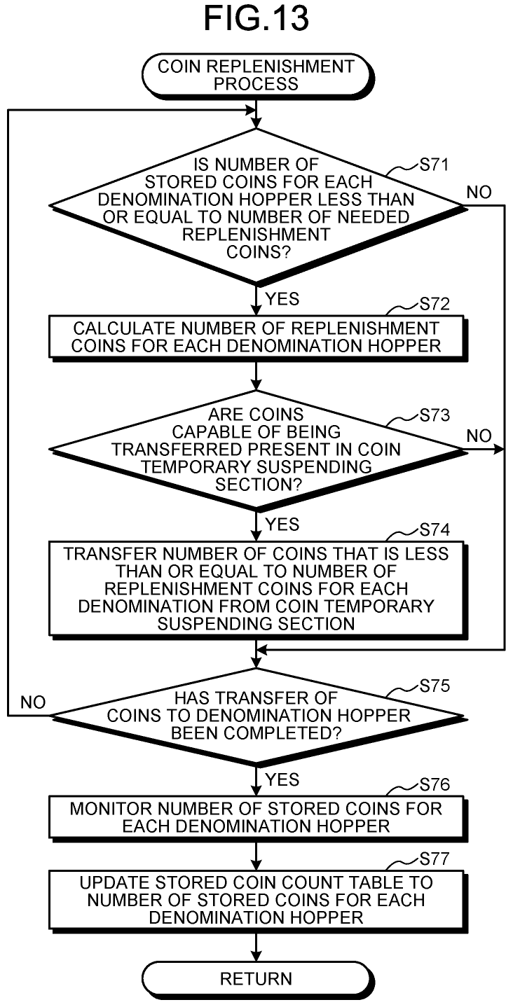

If the withdrawal of change has been completed (Yes at Step S29), the deposit and withdrawal apparatus 1 prints out a purchase receipt indicating a total amount of the product through the printer 44 (Step S30), and proceeds to M2 illustrated in FIG. 9 after having performed the coin replenishment process illustrated in FIG. 13 (Step S31). Moreover, the coin replenishment process is a process for replenishing coins for each denomination into the respective denomination hopper 21 included in the coin recycling unit 11.

If change is not needed (No at Step S25), the deposit and withdrawal apparatus 1 proceeds to Step S30 in order to print out the purchase receipt indicating the total amount of the product. If the withdrawal of the coins is not needed (No at Step S27), the deposit and withdrawal apparatus 1 proceeds to Step S29 in order to judge whether the withdrawal of change has been completed. Furthermore, if the withdrawal of change has not been completed (No at Step S29), the deposit and withdrawal apparatus 1 proceeds to Step S27 in order to judge whether withdrawal of the coin is needed.

If the deposit amount is not greater than or equal to the total amount (No at Step S23), the deposit and withdrawal apparatus 1 determines that the deposit amount does not satisfy the total amount and proceeds to Step S19 in order to judge whether money is deposited. If money is not deposited (No Step S19) or if a coin is not deposited (No at Step S20), the deposit and withdrawal apparatus 1 proceeds to Step S22 in order to calculate a deposit amount. If a payment is not performed by cash (No at Step S17), the deposit and withdrawal apparatus 1 proceeds to another settlement process performed by, for example, a credit card or the like.

If the scanning of the bar codes of all of the products corresponding to the accounting target has not been completed (No at Step S15), the deposit and withdrawal apparatus 1 proceeds to Step S13 in order to judge whether the scanning of the bar code of the remaining products corresponding to the accounting targets has been completed. If the scanning of the bar code of the products has not been completed (No at Step S13), the deposit and withdrawal apparatus 1 proceeds to Step S15 in order to judge whether the scanning of all of the products corresponding to the accounting target has been completed.

If the deposit and withdrawal apparatus 1 judges that the accounting process of the product is not started (No at Step S12), the deposit and withdrawal apparatus 1 proceeds to Step S11 in order to judge whether the current mode is the collection mode.

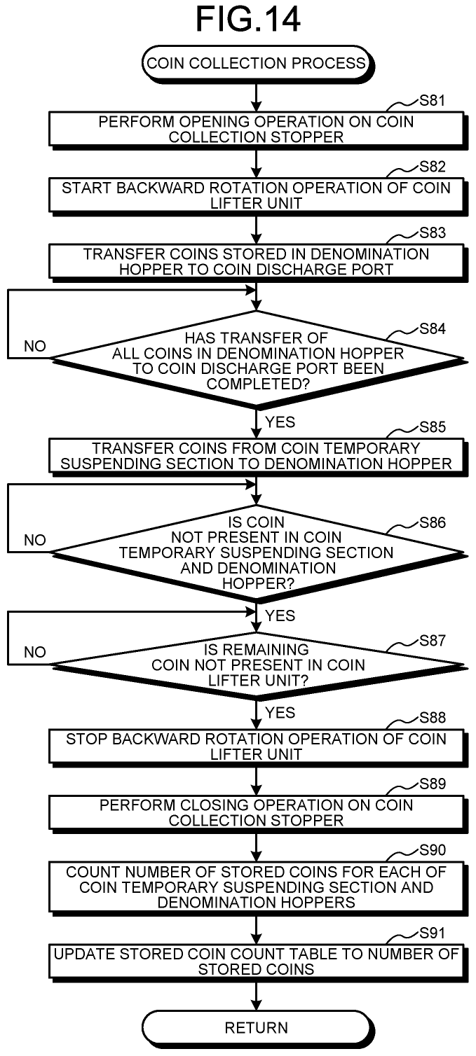

If the current mode is the collection mode (Yes at Step S11), the deposit and withdrawal apparatus 1 instructs the banknote recycling unit 2 to perform collection (Step S33), and performs a coin collection process illustrated in FIG. 14 (Step S34). Moreover, the deposit and withdrawal apparatus 1 performs each of a collection process on the banknote recycling unit 2 and a collection process on the coin recycling unit 11.

After the deposit and withdrawal apparatus 1 performs the coin collection process, the deposit and withdrawal apparatus 1 judges whether a transfer of money to each of the banknote collection cassette and the coin collection cassette 13 has been completed (Step S35). If the transfer of the money to each of the banknote collection cassette and the coin collection cassette 13 has been completed (Yes at Step S35), the deposit and withdrawal apparatus 1 instructs the coin acceptor 14 and the banknote recycling unit 2 to stop the operation (Step S36), and calculates a collection amount of the deposit and withdrawal apparatus 1 (Step S37). Furthermore, the deposit and withdrawal apparatus 1 prints out a collection report including a collection amount through the printer 44 (Step S38), and proceeds to Step S12 in order to judge whether the accounting process of a product it to be started.

FIG. 11 is a flowchart illustrating an example of a processing operation of the coin unit 3 related to a first coin sorting process. In FIG. 11, the coin unit 3 judges, on the basis of the discrimination result obtained by the coin acceptor 14, whether the coin inserted into the coin acceptor 14 is a counterfeit coin (Step S51). If the inserted coin is a counterfeit coin (Yes at Step S51), the coin unit 3 sets the inserted coin to the coin withdrawal port 15 as the distribution destination to be distributed by the coin sorting unit 16 (Step S52), and ends the processing operation illustrated in FIG. 11. As a result, the counterfeit coin is discharged from the coin withdrawal port 15.

If the inserted coin is not a counterfeit coin (No at Step S51), the coin unit 3 judges whether a sum total of the number of coins of the number of inserted coins and the number of currently stored coins stored in the coin recycling unit 11 is less than or equal to the lower limit on the number of coins (Step S53). Moreover, in the process at Step S53, it is judged, for each denomination, whether the sum total of the number of coins is less than or equal to the lower limit on the number of coins. Furthermore, the number of currently stored coins in the coin recycling unit 11 corresponds to the number of stored coins, for each denomination, that are being stored in the respective denomination hoppers 21 and the coin temporary suspending section 25. If the sum total of the number of coins is less than or equal to the lower limit on the number of coins (Yes at Step S53), the coin unit 3 sets the inserted coins into the coin recycling unit 11 as the distribution destination to be distributed by the coin sorting unit 16 (Step S54), and ends the processing operation illustrated in FIG. 11. As a result, the inserted coins are distributed to the coin recycling unit 11, i.e., to the coin temporary suspending section 25 or the respective denomination hoppers 21.

If the sum total of the number of coins of the number of inserted coins and the number of currently stored coins in the coin recycling unit 11 is not less than or equal to the lower limit on the number of coins (No at Step S53), the coin unit 3 judges whether the sum total of the number of coins is greater than or equal to the upper limit on the number of coins (Step S55). If the sum total of the number of coins is not greater than or equal to the upper limit on the number of coins (No at Step S55), the coin unit 3 sets the inserted coins into the coin recycling unit 11 as the distribution destination to be distributed by the coin sorting unit 16 (Step S56), and ends the processing operation illustrated in FIG. 11. As a result, the inserted coins are distributed to the coin recycling unit 11, i.e., to the coin temporary suspending section 25 or the respective denomination hoppers 21.

If the sum total of the number of coins is greater than or equal to the upper limit on the number of coins (Yes at Step S55), the coin unit 3 sets the inserted coins into the coin overflow cassette 12 as the distribution destination to be distributed by the coin sorting unit 16 (Step S57), and ends the processing operation illustrated in FIG. 11. As a result, the inserted coins are directly distributed to the coin overflow cassette 12 such that the coin recycling unit 11 does not enter the full state.

In FIG. 11, if the sum total of the number of coins for each denomination is less than or equal to the lower limit on the number of coins, or, if the sum total of the number of coins for each denomination is less than the upper limit on the number of coins, the coin unit 3 distributes the inserted coins associated with the subject denominations to the coin recycling unit 11 (the coin temporary suspending section 25 or the denomination hopper 21). As a result, it is possible to use the inserted coins for a deposit and a withdrawal into and from the coin recycling unit 11.

If the sum total of the number of coins for each denomination is greater than or equal to the upper limit on the number of coins, the coin unit 3 distributes the inserted coins associated with the subject denominations to the coin overflow cassette 12. As a result, it is possible to avoid the coin recycling unit 11 from entering the full state caused by the inserted coins.

FIG. 12 is a flowchart illustrating an example of a processing operation of the coin unit 3 related to the coin withdrawal process. In FIG. 12, the coin unit 3 transfers all of the coins targeted for change withdrawn from the respective denomination hoppers 21 to the coin discharge port 22 (Step S61). After the coin unit 3 transfers all of the coins targeted for change withdrawn from the respective denomination hoppers 21 to the coin discharge port 22, the coin unit 3 judges whether all of the coins targeted for change have been transferred to the coin discharge port 22 (Step S62).

If the transfer of the coins to the coin discharge port 22 has been completed (Yes at Step S62), the coin unit 3 starts the forward rotation operation of the coin lifter unit 17 (Step S63), and transfers all of the coins targeted for change to the coin withdrawal port 15. Then, the coin unit 3 judges whether the transfer of all of the coins targeted for change to the coin withdrawal port 15 has been completed (Step S64). If the transfer of all of the coins targeted for change to the coin withdrawal port 15 has been completed (Yes at Step S64), the coin unit 3 judges whether remaining coins are present in the coin lifter unit 17 (Step S65).

If remaining coins are not present in the coin lifter unit 17 (No at Step S65), the coin unit 3 stops the forward rotation operation of the coin lifter unit 17 (Step S66), and ends the processing operation illustrated in FIG. 12.

If not all of the coins targeted for change have been transferred to the coin discharge port 22 (No at Step S62), the coin unit 3 proceeds to Step S62 in order to judge whether all of the coins have been transferred to the coin discharge port 22. If not all of the coin have been transferred to the coin withdrawal port 15 (No at Step S64), the coin unit 3 proceeds to Step S64 in order to judge whether all of the coins have been transferred to the coin withdrawal port 15. If a remaining coin is present in the coin lifter unit 17 (Yes at Step S65), the coin unit 3 proceeds to Step S65 in order to judge whether a remaining coin is present in the coin lifter unit 17.

In FIG. 12, the coin unit 3 transfers the coins used for change from the coin discharge port 22 included in the coin recycling unit 11, and then, transfers the coins used for change to the coin withdrawal port 15 through the coin lifter unit 17. As a result, it is possible to allow the coins used for change to be withdrawn to the coin withdrawal port 15.

FIG. 13 is a flowchart illustrating an example of a processing operation of the coin unit 3 related to the coin replenishment process. In FIG. 13, the coin unit 3 judges whether the number of stored coins for each of the denomination hoppers 21 is less than or equal to the number of needed replenishment coins (Step S71). If the number of stored coins for each of the denomination hoppers 21 is less than or equal to the number of needed replenishment coins (Yes Step S71), the coin unit 3 determines that replenishment is needed, and calculates the number of replenishment coins to be replenished into the respective denomination hoppers 21 (Step S72), and judges whether the coins that are able to be transferred is present in the coin temporary suspending section 25 (Step S73).

If the coins that are able to be transferred is present in the coin temporary suspending section 25 (Yes at Step S73), the coin unit 3 transfers the number of coins that is less than or equal to the number of needed replenishment coins for each denomination from the coin temporary suspending section 25 to the respective denomination hoppers 21 through the coin conveying unit 26 (Step S74). The coin unit 3 judges whether the transfer of the coins to the denomination hopper 21 has been completed (Step S75).

If the transfer of the coins to the denomination hopper 21 has been completed (Yes at Step S75), the coin unit 3 monitors the number of stored coins for each of the denomination hoppers 21 (Step S76), updates the number of stored coins for each of the denomination hoppers 21 to the stored coin count table 31 on the basis of the monitoring result (Step S77), and ends the processing operation illustrated in FIG. 13.

If the number of stored coins for each of the denomination hoppers 21 is not less than or equal to the number of needed replenishment coins (No at Step S71), the coin unit 3 proceeds to Step S75 in order to judge whether the transfer of the coins to the denomination hopper 21 has been completed. If the coins targeted for the transfer to the coin temporary suspending section 25 are not present (No at Step S73), the coin unit 3 proceeds to Step S75 in order to judge whether the transfer of the coins to the respective denomination hoppers 21 has been completed. If the transfer of the coins to the respective denomination hoppers 21 has not been completed (No at Step S75), the coin unit 3 proceeds to Step S71 in order to judge whether the number of stored coins for each of the denomination hoppers 21 is less than or equal to the number of needed replenishment coins.

In FIG. 13, if the number of stored coins for each denomination in the respective denomination hoppers 21 is less than or equal to the number of needed replenishment coins, and also, if the coins associated with the corresponding denominations that can be transferred are present in the coin temporary suspending section 25, the coin unit 3 replenishes the coins associated with the corresponding denominations that can be transferred to the coin temporary suspending section 25 into the denomination hopper 21. As a result, the denomination hoppers 21 automatically replenishes the needed denomination coins.

FIG. 14 is a flowchart illustrating an example of a processing operation of the coin unit 3 related to the coin collection process. In FIG. 14, the coin unit 3 performs an opening operation on the coin collection stopper 18 (Step S81), and starts the backward rotation operation of the coin lifter unit 17 (Step S82). When the coin unit 3 starts the backward rotation operation of the coin lifter unit 17, the coin unit 3 transfers the coins stored in the respective denomination hoppers 21 subjected to the opening operation by the coin collection stopper 18 to the coin discharge port 22 (Step S83). The coin unit 3 judges whether the transfer of all of the coins in the denomination hoppers 21 to the respective coin discharge ports 22 has been completed (Step S84).

If the transfer of all of the coins to the coin discharge port 22 has been completed (Yes at Step S84), the coin unit 3 transfers the coins from the coin temporary suspending section 25 to the respective denomination hoppers 21 (Step S85). After the coin unit 3 transfers the coins from the coin temporary suspending section 25 to the respective denomination hoppers 21, the coin unit 3 judges whether any coin is present in each of the coin temporary suspending section 25 and the associated denomination hoppers 21 (Step S86). If no coin is present in each of the coin temporary suspending section 25 and the associated denomination hopper 21 (Yes at Step S86), the coin unit 3 judges whether a remaining coin is present in the coin lifter unit 17 (Step S87).

If no remaining coin is present in the coin lifter unit 17 (Yes at Step S87), the coin unit 3 stops the backward rotation operation of the coin lifter unit 17 (Step S88). After the coin unit 3 stops the backward rotation operation of the coin lifter unit 17, the coin unit 3 performs a closing operation on the coin collection stopper 18 (Step S89), and counts the number of stored coins for each of the coin temporary suspending section 25 and the denomination hoppers 21 (Step S90). Furthermore, the coin unit 3 updates the stored coin count table 31 by the number of stored coins (Step S91), and ends the processing operation illustrated in FIG. 14.

If a withdrawal of all of the coins stored in the respective denomination hoppers 21 has not been completed (No at Step S84), the coin unit 3 proceeds to Step S84 in order to judge whether a withdrawal of all of the coins in the respective denomination hoppers 21 has been completed. If some coin are present in each of the coin temporary suspending section 25 and the denomination hoppers 21 (No at Step S86), the coin unit 3 proceeds to Step S86 in order to judge whether a coin is present in each of the coin temporary suspending section 25 and the associated denomination hoppers 21. If a remaining coin is present in the coin lifter unit 17 (No at Step S87), the coin unit 3 proceeds to Step S87 in order to judge whether a remaining coin is present in the coin lifter unit 17.

In FIG. 14, If the current mode is the collection mode, the coin unit 3 performs an opening operation on the coin collection stopper 18 and performs the backward rotation operation on the coin lifter unit 17. The coin unit 3 transfers the coins to be stored in the coin recycling unit 11 to the coin discharge port 22, and stores the coins in the coin collection cassette 13 through the coin lifter unit 17. As a result, it is possible to store the coins that are present in the coin recycling unit 11 into the coin collection cassette 13.

The deposit and withdrawal apparatus 1 according to the first embodiment distributes the coins deposited in the coin acceptor 14 to the coin recycling unit 11 or the coin overflow cassette 12 on the basis of the judgement result obtained by the judgement unit 19A. As a result, it is possible to distribute the inserted coins to the coin recycling unit 11 or the coin overflow cassette 12.

The deposit and withdrawal apparatus 1 judges whether the sum total of the number of coins of the number of deposited coins and the number of stored coins stored in the coin recycling unit 11 is greater than or equal to the upper limit on the number of coins of the coin recycling unit 11. If the sum total of the number of coins is greater than or equal to the upper limit on the number of coins, the deposit and withdrawal apparatus 1 distributes the deposited coin to the coin overflow cassette 12. If the sum total of the number of coins is not greater than or equal to the upper limit on the number of coins, the deposit and withdrawal apparatus 1 distributes the deposited coins to the coin recycling unit 11. As a result, it is possible to suppress a reduction in operation rate of the accounting process by avoiding the coin recycling unit 11 from entering an upper limit state, for example, the full state or the near full state.

The deposit and withdrawal apparatus 1 judges whether the sum total of the number of coins of the number of deposited coins and the number of stored coins that are stored in the coin recycling unit 11 and that are associated with the respective denominations is greater than or equal to the upper limit on the number of coins for each denomination of the coin recycling unit 11. If the sum total of the number of coins for each denomination is greater than or equal to the upper limit on the number of coins associated with the respective denominations, the deposit and withdrawal apparatus 1 distributes the deposited coins associated with the subject denomination to the coin overflow cassette 12. If the sum total of the number of coins for each denomination is not greater than or equal to the upper limit on the number of coins associated with the subject denomination, the deposit and withdrawal apparatus 1 distributes the deposited coins associated with the denomination to the coin recycling unit 11. As a result, it is possible to suppress a reduction in operation rate of the accounting process by avoiding the coin recycling unit 11 from entering the upper limit on the number of coins for each denomination, for example, the full state or the near full state.

In the deposit and withdrawal apparatus 1, the coin lifter unit 17 that conveys the coins received from the coin discharge port 22 included in the coin recycling unit 11 to the coin withdrawal port 15 or the coin collection cassette 13 is arranged. If the deposit and withdrawal apparatus 1 detects a collection instruction, the deposit and withdrawal apparatus 1 conveys the coins that are being stored in the coin recycling unit 11 to the coin collection cassette 13 through the coin lifter unit 17. Furthermore, the deposit and withdrawal apparatus 1 conveys the coins that are targeted for a deposit and that are stored in the coin recycling unit 11 to the coin withdrawal port 15 through the coin lifter unit 17.

Moreover, a case has been described as one example in which the deposit and withdrawal apparatus 1 according to the first embodiment distributes the coins inserted into the coin acceptor 14 to the coin recycling unit 11 or the coin overflow cassette 12 on the basis of the number of stored coins for each denomination stored in each of the coin temporary suspending section 25 and the denomination hoppers 21 that are included in the coin recycling unit 11. However, in addition to the number of stored coins for each denomination, for example, an embodiment of a case of previously setting a deposit available coin and a deposit inhibition coin, judging whether the coin inserted into the coin acceptor 14 is the deposit available coin or the deposit inhibition coin, and distributing the coin inserted into the coin acceptor 14 to the coin recycling unit 11 or the coin overflow cassette 12 on the basis of the judgement result will be described a second embodiment below.

### Second Embodiment

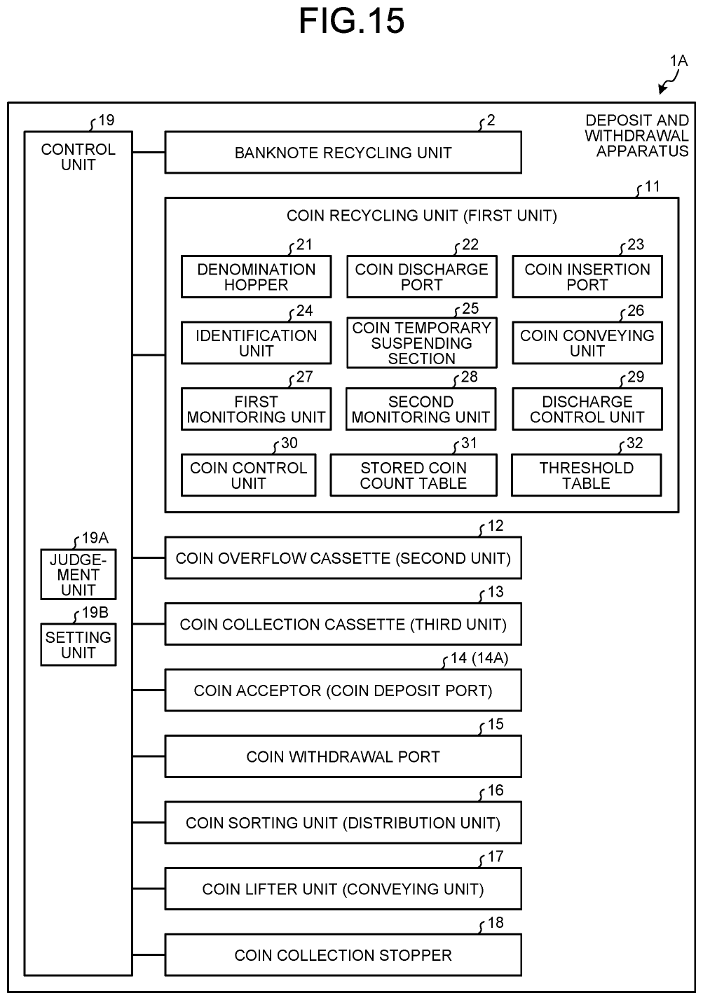

FIG. 15 is a block diagram illustrating an example of a functional configuration of a deposit and withdrawal apparatus 1A according to the second embodiment. Moreover, by assigning the same reference numerals to components having the same configuration as those in the deposit and withdrawal apparatus 1 according to the first embodiment, overlapped descriptions of the configuration and the operation thereof will be omitted. The deposit and withdrawal apparatus 1A illustrated in FIG. 15 is different from the deposit and withdrawal apparatus 1 according to the first embodiment in that a setting unit 19B is added to the control unit 19. The setting unit 19B sets a deposit inhibition coin or a deposit available coin. The deposit inhibition coin is a coin indicating that a deposit of coins into the coin recycling unit 11 is inhibited. The deposit available coin is a coin indicating that a deposit of coins into the coin recycling unit 11 is accepted.

The setting unit 19B sets, if the number of currently stored coins for each denomination in the coin recycling unit 11 (the denomination hopper 21 and the coin temporary suspending section 25) is greater than or equal to the upper limit on the number of coins for each denomination in the coin recycling unit 11, the coins associated with the subject denominations to the deposit inhibition coins. The setting unit 19B sets, if the number of currently stored coins for each denomination in the coin recycling unit 11 (the denomination hopper 21 and the coin temporary suspending section 25) is less than the upper limit on the number of coins for each denomination in the coin recycling unit 11, the coins associated with the subject denominations to the deposit available coins.

The judgement unit 19A judges whether the coin inserted into the coin acceptor 14 is the deposit inhibition coin or the deposit available coin. If the coin inserted into the coin deposit port 14A is a deposit inhibition coin, the coin sorting unit 16 distributes the deposit inhibition coin to the coin withdrawal port 15. Furthermore, if the coin inserted into the coin deposit port 14A is a deposit available coin, which will be described later, the coin sorting unit 16 distributes the deposit available coin to the coin recycling unit 11 or the coin overflow cassette 12.

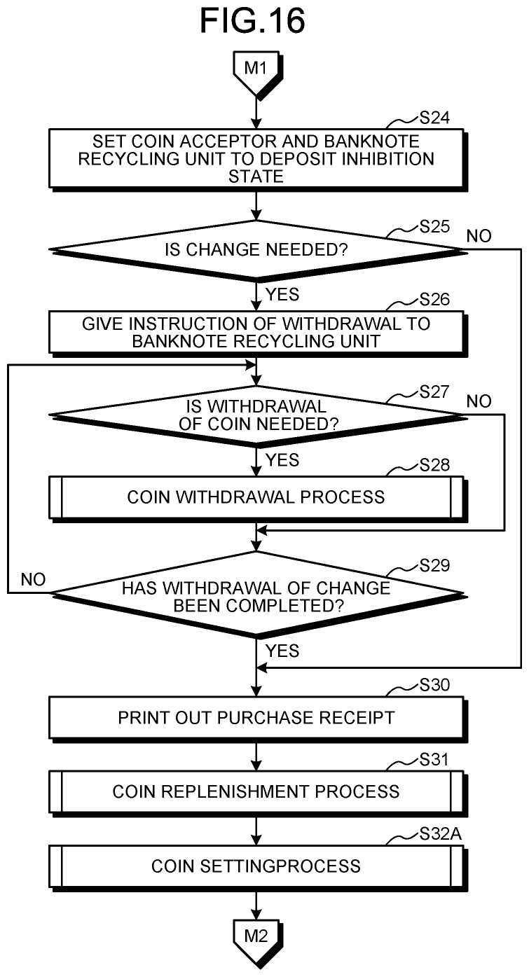

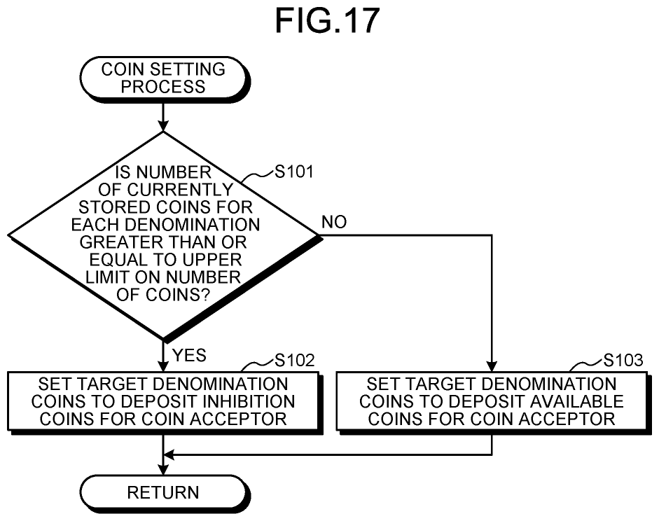

FIG. 16 is a flowchart illustrating an example of a processing operation of the deposit and withdrawal apparatus 1A related to a second deposit and withdrawal process. In M1 illustrated in FIG. 16, the deposit and withdrawal apparatus 1A performs the coin replenishment process at Step S32, and then, performs a coin setting process illustrated in FIG. 17 (Step S32A). Furthermore, after having performed the coin setting process at Step S32A, the deposit and withdrawal apparatus 1A proceeds to M2 illustrated in FIG. 9.

FIG. 17 is a flowchart illustrating an example of a processing operation of the coin unit 3 related to the coin setting process. In FIG. 17, the setting unit 19B included in the coin unit 3 judges whether the number of stored coins for each denomination in the coin recycling unit 11 (the denomination hopper 21 and the coin temporary suspending section 25) is greater than or equal to the upper limit on the number of coins (Step S101). If the number of stored coins for each denomination is greater than or equal to the upper limit on the number of coins (Yes at Step S101), the setting unit 19B sets the number of denomination coins that is greater than or equal to the upper limit on the number of coins to the deposit inhibition coins indicating that a deposit of coins into the coin acceptor 14 is inhibited (Step S102), and ends the processing operation illustrated in FIG. 17.

If the number of suspended coins for each denomination is not greater than or equal to the upper limit on the number of coins (No at Step S101), the setting unit 19B sets the number of denomination coins that is less than the upper limit on the number of coins to the deposit available coins indicating that a deposit of coins into the coin acceptor 14 is available (Step S103), and ends the processing operation illustrated in FIG. 17.

In FIG. 17, if the number of stored coins for each denomination is greater than or equal to the upper limit on the number of coins, the coin unit 3 sets the coins associated with the subject denominations to the deposit inhibition coins. As a result, it is possible to previously set the deposit inhibition coin for each denomination.

If the number of stored coins for each denomination is less than the upper limit on the number of coins, the coin unit 3 sets the coins associated with the subject denominations to the deposit available coins. As a result, it is possible to previously set the deposit available coin for each denomination.

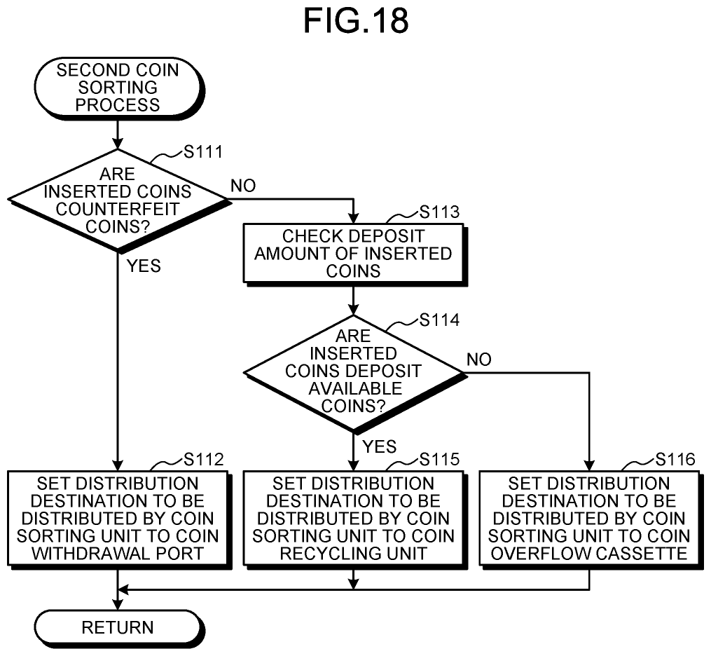

FIG. 18 is a flowchart illustrating an example of a processing operation of the coin unit 3 related to the second coin sorting process. In FIG. 18, the coin unit 3 judges whether the inserted coins inserted into the coin acceptor 14 are counterfeit coins (Step S111). If the inserted coins are counterfeit coins (Yes at Step S111), the coin unit 3 sets the inserted coins to the coin withdrawal port 15 as the distribution destination to be distributed by the coin sorting unit 16 (Step S112), and ends the processing operation illustrated in FIG. 18. As a result, the counterfeit coins are discharged from the coin withdrawal port 15.

If the inserted coins are not counterfeit coins (No at Step S111), the coin unit 3 checks a deposit amount of the inserted coins (Step S113). After having checked the deposit amount of the inserted coins, the coin unit 3 judges whether the inserted coins are deposit available coins (Step S114).

If the inserted coins are the deposit available coins (Yes at Step S114), the coin unit 3 sets the inserted coins to the coin recycling unit 11 as the distribution destination to be distributed by the coin sorting unit 16 (Step S115), and ends the processing operation illustrated in FIG. 18. As a result, the inserted coins are distributed to the coin recycling unit 11, i.e., to the coin temporary suspending section 25 or the associated denomination hoppers 21.

If the inserted coins are not the deposit available coins (No at Step S114), i.e., if the inserted coins are the deposit inhibition coins, the coin unit 3 sets the inserted coins to the coin overflow cassette 12 as the distribution destination to be distributed by the coin sorting unit 16 (Step S116), and ends the processing operation illustrated in FIG. 18. As a result, the inserted coins are directly distributed to the coin overflow cassette 12 such that the coin recycling unit 11 does not enter the full state.

In FIG. 18, if the inserted coins in the coin acceptor 14 are the deposit inhibition coins, the coin unit 3 distributes the inserted coins to the coin overflow cassette 12. As a result, it is possible to avoid the coin recycling unit 11 from entering the full state caused by the inserted coins.

If the inserted coins in the coin acceptor 14 are the deposit available coins, the coin unit 3 distributes the inserted coins to the coin recycling unit 11. As a result, it is possible to use the inserted coins for a deposit and a withdrawal into and from the coin recycling unit 11.

The deposit and withdrawal apparatus 1A according to the second embodiment judges whether the deposited coins are the deposit inhibition coins or the deposit available coins. If the deposited coins are the deposit inhibition coins, the deposit and withdrawal apparatus 1A distributes the deposited coins to the coin overflow cassette 12, whereas, if the deposited coins are the deposit available coins, the deposit and withdrawal apparatus 1A distributes the deposited coins to the coin recycling unit 11. As a result, it is possible to distribute the inserted coins to the coin recycling unit 11 or the coin overflow cassette 12.

The deposit and withdrawal apparatus 1A judges whether the deposited coins associated with the respective denominations are the deposit inhibition coins or the deposit available coins. If the deposited coins associated with the respective denominations are the deposit inhibition coins, the deposit and withdrawal apparatus 1A distributes the deposited coins associated with the respective denominations to the coin overflow cassette 12, whereas, if the deposited coins associated with the respective denominations are the deposit available coins, the deposit and withdrawal apparatus 1A distributes the deposited coins associated with the respective denominations to the coin recycling unit 11. As a result, it is possible to distribute the inserted coins to the coin recycling unit 11 or the coin overflow cassette 12 for each denomination.

If the number of currently stored coins for each denomination stored in the coin recycling unit 11 is greater than or equal to the upper limit on the number of coins for each denomination stored in the coin recycling unit 11, the deposit and withdrawal apparatus 1A sets the coins associated with the subject denominations to the deposit inhibition coin. Furthermore, if the number of currently stored coins for each denomination stored in the coin recycling unit 11 is less than the upper limit on the number of coins for each denomination stored in the coin recycling unit 11, the deposit and withdrawal apparatus 1A sets the coins associated with the subject denomination to the deposit available coins. As a result, if the inserted coins are the deposit inhibition coins, the inserted coins are stored in the coin overflow cassette 12, whereas, if the inserted coins are the deposit available coins, the inserted coins are stored in the coin recycling unit 11; therefore, it is possible to suppress a reduction in operation rate of the accounting process by avoiding the coin recycling unit 11 from entering the full state or the near full state.

### Explanation of Effects of Embodiments

In the deposit and withdrawal apparatus 1 (1A), coins are distributed to the coin overflow cassette 12 such that the coin recycling unit 11 that stores therein the coins does not enter the full state even if the coin storage capacity of the coin recycling unit 11 is decreased.

In the deposit and withdrawal apparatus 1 (1A), on the basis of the number of currently stored coins stored in the coin recycling unit 11, the coins inserted into the coin acceptor 14 are distributed to the coin recycling unit 11 or the coin overflow cassette 12. As a result, it is possible to suppress a reduction in operation rate of the accounting process by avoiding the coin recycling unit 11 from entering the full state while reducing the coin storage capacity of the coin recycling unit 11 and decreasing the size of the deposit and withdrawal apparatus (1A) itself.

The deposit and withdrawal apparatus 1 distributes the coins to the coin overflow cassette 12 or the coin collection cassette 13, so that the deposit and withdrawal apparatus 1 is able to share a transfer amount and also classify the coins into the coins stored in the coin overflow cassette 12 as preparation money and the coins stored in the coin collection cassette 13 as store proceeds.

In the deposit and withdrawal apparatus 1, the coin lifter unit 17 that conveys the coins is arranged at the coin withdrawal port 15 that is disposed at the upper part of the coin discharge port 22 included in the coin recycling unit 11, and the coin overflow cassette 12 and the coin collection cassette 13 are arranged at the lower part of the coin discharge port 22. As a result, it is possible to decrease the width of the coin recycling unit 11 by reducing the coin storage capacity of the coin recycling unit 11.

The coin recycling unit 11 is structured such that the coin discharge port 22 configured as a single unit is opened and closed in accordance with an opening and closing operation of the coin collection stopper 18, so that it is possible to perform discharge control of the coins in the denomination hopper 21.

Furthermore, in a case where the coins are transferred from the coin temporary suspending section 25 to each of the denomination hoppers 21 that are included in the coin recycling unit 11, the processing time taken to discriminate the coins one by one is increased; however, the coins are distributed to the coin overflow cassette 12 in order to avoid the full state of the coins. Accordingly, the number of coins inserted into the coin recycling unit 11 is reduced and it is thus possible to reduce the processing time needed for the discrimination by reducing.

### Other Embodiments

In the deposit and withdrawal apparatus 1 (1A) according to the present embodiments, for example, a change dispensing apparatus or the like for depositing and withdrawing coins is exemplified; however, any apparatus may be used as long as an apparatus performs deposit and withdrawal of coins, and appropriate modifications are possible.

A case has been described as one example in which the deposit and withdrawal apparatus 1 according to the first embodiment distributes the coins inserted into the coin acceptor 14 to the coin recycling unit 11 or the coin overflow cassette 12 on the basis of the number of stored coins for each denomination stored in each of the coin temporary suspending section 25 and the denomination hoppers 21 included in the coin recycling unit 11. However, the example is not limited to the number of stored coins for each denomination, the coins may be distributed on the basis of the number of stored coins without depending on the denominations, and appropriate modifications are possible.

With the deposit and withdrawal apparatus 1A according to the second embodiment described above, a case has been described as one example in which the deposit available coin or the deposit inhibition coin is previously set for each denomination of the coin on the basis of the condition in which the number of currently stored coins is greater than or equal to the upper limit on the number of coins. However, the condition is not limited to denominations or the condition in which the number of currently stored coins is greater than or equal to the upper limit on the number of coins. For example, the deposit available coin or the deposit inhibition coin may also be previously set on the basis of a condition whether the coin is a commemorative coin, and appropriate modifications are possible. For example, in a case where a commemorative coin is set as a deposit inhibition coin, if it is judged that the commemorative coin inserted into the coin acceptor 14 is the deposit inhibition coin, the deposit and withdrawal apparatus 1A distributes the commemorative coin to the coin overflow cassette 12. As a result, it is possible to store the commemorative coin in the coin overflow cassette 12 without discharging the commemorative coin to the coin withdrawal port 15.

Furthermore, with the deposit and withdrawal apparatus 1A, a case has been described as one example in which the deposit inhibition coin or the deposit available coin is set on the basis of the condition in which the number of currently stored coins is the number of stored coins in the full state as the upper limit on the number of coins. However, the upper limit on the number of coins is not limited to the number of stored coins in the full state. The number of stored coins in the near full state may be used, and appropriate modifications are possible.

Each of the components in the units illustrated in the drawings is not always physically configured as illustrated in the drawings. In other words, the specific shape of a separate or integrated unit is not limited to the drawings; however, all or part of the unit can be configured by functionally or physically separating or integrating any of the units depending on various kinds of loads or use conditions.

Furthermore, all or any part of various processing functions performed by each unit may also be executed by a central processing unit (CPU) (or a microcomputer, such as a micro processing unit (MPU), a micro controller unit (MCU), or the like). Furthermore, all or any part of various processing functions may also be, of course, executed by programs analyzed and executed by the CPU (or the microcomputer, such as the MPU or the MCU), or executed by hardware by wired logic.

Accordingly, the disclosed technology has been conceived in light of the circumstances described above, and an object thereof is to provide a deposit and withdrawal apparatus or the like capable of sorting deposited coin into a coin recycling unit (a first unit) or another unit (a second unit).

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A deposit and withdrawal apparatus that includes a deposit port through which a coin is deposited, a withdrawal port through which the coin is withdrawn, and a first unit that is capable of storing the coin, the deposit and withdrawal apparatus comprising:
a second unit that is different from the first unit and that is capable of storing the coin;
a judgement unit that judges the coin deposited from the deposit port; and
a distribution unit that distributes, based on a judgement result of the judgement unit, the deposited coin to the first unit or the second unit.

2. The deposit and withdrawal apparatus according to claim 1, wherein
the judgement unit judges whether a sum total of the number of coins of the number of deposited coins and the number of stored coins stored in the first unit is greater than or equal to an upper limit on the number of storable coins in the first unit,
when the sum total of the number of coins is greater than or equal to the upper limit on the number of storable coins, the distribution unit distributes the deposited coin to the second unit, and
when the sum total of the number of coins is not greater than or equal to the upper limit on the number of storable coins, the distribution unit distributes the deposited coin to the first unit.

3. The deposit and withdrawal apparatus according to claim 1, wherein
the judgement unit judges whether a sum total of the number of coins, for each denomination, of the number of deposited coins and the number of stored coins stored in the first unit is greater than or equal to an upper limit on the number of storable coins for each denomination in the first unit,
when the sum total of the number of coins for each of the denominations is greater than or equal to the upper limit on the number of storable coins associated with the respective denominations, the distribution unit distributes the deposited denomination coin to the second unit, and
when the sum total of the number of coins for each of the denominations is not greater than or equal to the upper limit on the number of storable coins associated with the respective denominations, the distribution unit distributes the deposited denomination coin to the first unit.

4. The deposit and withdrawal apparatus according to claim 2, wherein the upper limit on the number of storable coins is the number of coins in the first unit in a near full state or in a full state.

5. The deposit and withdrawal apparatus according to claim 1, wherein
the judgement unit judges whether the deposited coin is a deposit inhibition coin or a deposit available coin,
when the deposited coin is the deposit inhibition coin, the distribution unit distributes the deposited coin to the second unit, and
when the deposited coin is the deposit available coin, the distribution unit distributes the deposited coin to the first unit.

6. The deposit and withdrawal apparatus according to claim 1, wherein
the judgement unit judges whether the deposited coin associated with a denomination is a deposit inhibition coin or a deposit available coin,
when the deposited coin associated with the denomination is the deposit inhibition coin, the distribution unit distributes the deposited coin associated with the denomination to the second unit, and
when the deposited coin associated with the denomination is the deposit available coin, the distribution unit distributes the deposited coin associated with the denomination to the first unit.

7. The deposit and withdrawal apparatus according to claim 6, further comprising a setting unit that
sets, when the number of currently stored coins for each denomination in the first unit is greater than or equal to an upper limit on the number of stored coins for each denomination in the first unit, the coin associated with the denomination to the deposit inhibition coin, and
sets, when the number of currently stored coins for each denomination in the first unit is less than the upper limit on the number of stored coins for each denomination in the first unit, the coin associated with the denomination to the deposit available coin.

8. The deposit and withdrawal apparatus according to claim 1, further comprising:
a third unit that is different from the first unit and the second unit and that is capable of storing the coin; and
a conveying unit that conveys, when a collection instruction is detected, the coin that are being stored in the first unit to the third unit, and that conveys the coin that is targeted for being withdrawn from the first unit to the withdrawal port.

9. The deposit and withdrawal apparatus according to claim 8, wherein
the first unit is a recycle unit that stores the coin that is able to be withdrawn from the withdrawal port,
the second unit is an overflow cassette that stores the coin that is not able to be withdrawn from the withdrawal port, and
the third unit is a collection cassette that collects the coin in the deposit and withdrawal apparatus.

10. A coin distribution method used in a deposit and withdrawal apparatus that includes a deposit port through which a coin is deposited, a withdrawal port through which the coin is withdrawn, a first unit that is capable of storing the coin, and a second unit that is different from the first unit and that is capable of storing the coin, the coin distribution method comprising:
judging the coin deposited from the deposit port; and
distributing, based on a judgement result, the deposited coin to the first unit or the second unit.
